(19) United States
(12) Patent Application Publication
(10) Pub. No.: US 2019/0262771 A1
(43) Pub. Date: Aug. 29, 2019

(54) Low-Temperature Oxidation Catalyst With Particularly Marked Hydrophobic Properties ForThe Oxidation Of Organic Pollutants

(71) Applicant: Clariant Produkte (Deutschland) GmbH, Frankfurt / Main (DE)

(72) Inventors: Arno TISSLER, Tegernheim (DE); Frank KLOSE, Rosenheim (DE); Roderik ALTHOFF, Kolbermoor (DE); Mika ENDLER, Rosenheim (DE); Patrick Mueller, Prien am Chiemsee (DE); Grigory REZNIKOV, Bad Aiblin (DE); Margit SCHUSCHKE, Bruckmuehl (DE)

(21) Appl. No.: 16/407,538

(22) Filed: May 9, 2019

Related U.S. Application Data
(62) Division of application No. 14/118,358, filed on Jan. 31, 2014, now abandoned.
Application No. 14/118,358 is a division of application No. 16/176,363, filed on Oct. 31, 2018.

(30) Foreign Application Priority Data
May 18, 2011 (DE) 10 2011 101 877.1

(51) Int. Cl. B01D 53/86; B01J 29/22; B01J 29/74; B01J 29/12; B01J 35/04; B01J 35/10; B01J 37/02; B01J 29/068; B01J 29/44; B01J 29/54; B01J 29/67; B01J 35/02

(52) U.S. Cl. CPC B01D 53/8687; B01J 29/85; B01D 53/8668; B01J 29/7415; B01J 29/12; B01J 35/04; B01J 35/108; B01J 37/0246; B01J 37/0248; B01J 29/068; B01J 29/44; B01J 29/54; B01J 29/67; B01J 29/7407; B01J 29/7423; B01J 29/743; B01J 29/7446; B01J 29/7469; B01J 35/1095; B01J 35/1038; B01J 35/1023; B01J 35/1019; B01J 35/023; B01J 29/7484; B01D 2255/9205; B01J 2229/42; B01D 2257/708; B01D 2255/1021; B01D 2255/1023; B01D 2255/1025; B01D 2255/1026; B01J 29/22

(57) ABSTRACT

The present invention relates to a catalyst comprising a macroporous noble metal-containing zeolite material and a porous SiO₂-containing binder, wherein the catalyst has a proportion of micropores of more than 70%, based on the total pore volume of the catalyst. The invention is additionally directed to a process for preparing the catalyst and to the use of the catalyst as an oxidation catalyst.

The present invention relates to a catalyst comprising a microporous noble metal-containing zeolite material and a porous SiO₂-containing binder, wherein the catalyst has a proportion of micropores of more than 70%, relative to the total pore volume of the catalyst. The invention is additionally directed to a method of producing the catalyst as well as to the use of the catalyst as oxidation catalyst.

Purifying exhaust gases by means of catalysts has been known for some time. For example, the exhaust gases from combustion engines are purified with so-called three-way catalysts (TWC). The nitrogen oxides are reduced with reductive hydrocarbons (HC) and carbon monoxide (CO).

Likewise, the exhaust gases from diesel engines are post-treated with catalysts. Here, carbon monoxide, unburnt hydrocarbons, nitrogen oxides and soot particles, for example, are removed from the exhaust gas. Unburnt hydrocarbons which are to be treated catalytically include paraffins, olefins, aldehydes and aromatics, among others.

Likewise, exhaust gases from power stations, as well as exhaust gases that form during industrial production processes, are purified with catalysts.

Catalysts for purifying exhaust gases which contain organic pollutants are generally sensitive to water vapour. Water vapour blocks the active centres on the catalyst surface, with the result that their activity is reduced. This is usually compensated for by higher levels of noble metal doping, which on the one hand increases the costs for the catalysts, and on the other hand, in the case of the known systems according to the state of the art, increases the tendency to sinter.

Furthermore, high water vapour partial pressures at low exhaust gas temperatures can lead, through capillary condensation, to the formation of a water film in the pores of the catalyst, which likewise leads to a deactivation which can, however, also be reversible. For economic reasons, it often not practical to additionally increase the exhaust gas temperature to avoid capillary condensation.

In many applications, heat recovery systems, which restrict the amount of energy available for heating the incoming gases, are also normally incorporated.

Thus what is desired is a catalyst which already has a high activity in the oxidation of organic pollutants, in particular of solvent-type pollutants, at low temperatures, for example under 300° C., even under high concentrations of water vapour, which also displays a low tendency to thermal sintering and moreover manages with significantly lower levels of noble metal doping.

The object of the present invention therefore consisted in providing a catalyst which has a high activity in the oxidation of organic pollutants at low temperatures, displays a low tendency to thermal sintering and requires a low noble metal proportion.

The object is achieved by a catalyst comprising a microporous noble metal-containing zeolite material and a porous SiO₂-containing binder, wherein the catalyst has a proportion of micropores of more than 70%, relative to the total pore volume of the catalyst.

It was surprisingly found that catalysts which comprise a microporous noble metal-containing zeolite material and a pure SiO₂ binder which has few meso- and macropores have a significantly higher activity, in particular in the oxidation of solvent-type air pollutants.

The catalyst preferably has a proportion of micropores of more than 70%, more preferably more than 80%, most preferably more than 90%, relative to the total pore volume of the catalyst.

In further embodiments of the catalyst according to the invention, the proportion of micropores is >72%, more preferably >76%, relative to the total pore volume of the catalyst.

For steric reasons, capillary condensation cannot take place in the micropores, and the diffusion paths to the catalytic centres are thus not blocked. Apart from that, the transport pores are so large that capillary condensation does not basically occur. In total, the catalyst is characterized by a micropore proportion >70% as well as a meso- and macropore proportion between 20 and 30%. The proportion of micropores is preferably <100%, more preferably <95%.

The catalyst according to the invention is thus a catalyst with polymodal pore distribution, i.e. it contains micropores, mesopores and also macropores. Within the context of the present invention, by the terms of micropores, mesopores and macropores is meant pores which have a diameter of <1 nanometre (micropores), a diameter of from 1 to 50 nanometres (mesopores), or a diameter of >50 nanometres (macropores). The micro- and meso-/macropore proportion is determined by means of the so-called t-plot method according to ASTM D-4365-85.

The integral pore volume of the catalyst is preferably more than 100 mm³/g, more preferably more than 180 mm³/g. The integral pore volume is preferably determined according to DIN ISO 9277 by means of nitrogen porosimetry or alternatively with noble gas porosimetry.

According to an embodiment of the catalyst, it is preferred that the zeolite material has an aluminium proportion of <2 mol.-%, more preferably <1 mol.-%, relative to the zeolite material.

Moreover, it is preferred that the binder component also does not contain significant quantities of aluminium. The binder preferably contains less than 0.04 wt.-%, more preferably less than 0.02 wt.-% aluminium, relative to the quantity of binder. Suitable binders are for example Ludox AS 40 or tetraethoxysilane with an Al₂O₃ proportion of <0.04 wt.-%.

According to an embodiment of the invention, it is preferred that the zeolite material contains 0.5 to 6.0 wt.-%, more preferably 0.6 to 5.0 wt.-%, even more preferably 0.7 to 4.0 wt.-% and particularly preferably 0.5 to <3.0 wt.-% noble metal, relative to the quantity of the zeolite material.

Moreover, in connection with a washcoat, it is preferred that the washcoat contains a noble metal loading of from 0.1 to 2.0 g/l, more preferably 0.4 to 1.5 g/l, even more preferably 0.45 to 1.0 g/l and most preferably 0.45 to 0.55 g/l, relative to the volume of the washcoat.

The noble metal is preferably selected from the group consisting of rhodium, iridium, palladium, platinum, ruthenium, osmium, gold and silver or combinations of the named metals as well as alloys of the named noble metals.

The noble metals can be present in the form of noble metal particles and also in the form of noble metal oxide particles. In the following, reference is made primarily to noble metal particles which, however, also include noble metal oxide particles, unless something else is expressly mentioned.

The particle size of the noble metal particles preferably has an average diameter of from 0.5 to 5 nanometres, more preferably an average diameter of from 0.5 to 3 nanometres and particularly preferably an average diameter of from 0.5 to 2 nanometres. The particle size can be determined for example by using TEM.

In principle, it is advantageous if the noble metal particles of the loaded zeolite material are as small as possible, as the particles then have a very high degree of dispersion. By the degree of dispersion is meant the ratio of the number of metal atoms which form the surface of the metal particles to the total number of metal atoms of the metal particles. However, a favourable average particle diameter also depends on the application in which the catalyst is to be used, as well as on the nature of the noble metal of the noble metal particles, the pore distribution and in particular the pore radii and channel radii of the zeolite material.

The noble metal particles are preferably located in the internal pore system of the zeolite. According to the invention, this means the micro-, meso- and macropores of the zeolite. The noble metal particles are preferably located (substantially) in the micropores of the zeolite.

The zeolite material contained in the catalyst according to the invention can be a zeolite and also a zeolite-like material. Examples of preferred zeolite materials are silicates, aluminosilicates, gallosilicates, germanosilicates, aluminophosphates, silicoaluminophosphates, metal aluminophosphates, metal aluminophosphosilicates, titanosilicates or titanoaluminosilicates. Which zeolite material is used depends on the one hand on the nature of the noble metal used on, or in, the zeolite material, and on the other hand on the application in which the catalyst is to be used.

A large number of methods are known in the state of the art to tailor the properties of zeolite materials, for example the structure type, the pore diameter, the channel diameter, the chemical composition, the ion exchangeability as well as activation properties, to a corresponding intended use. However, according to the invention, zeolite materials are generally preferred which correspond to one of the following structure types: AFI, AEL, BEA, CHA, EUO, FAU, FER, KFI, LTL, MAZ, MOR, MEL, MTW, OFF, TON and MFI. The named zeolite materials can be present in the sodium form and also in the ammonium form or in the H form. Zeolite materials that are produced using amphiphilic compounds are also preferred according to the invention. Preferred examples of such materials are named in U.S. Pat. No. 5,250,282 and are also incorporated into the present invention by reference.

According to a further embodiment of the catalyst according to the invention, it is preferred that the catalyst is present as powder, as full catalyst or as coating catalyst. A full catalyst can for example be an extruded shaped body, for example a monolith. Further preferred shaped bodies are for example spheres, rings, cylinders, perforated cylinders, trilobes or cones, wherein a monolith is particularly preferred, for example a monolithic honeycomb body.

It can furthermore be preferred that the catalyst according to the invention is applied to a support, i.e. is present as coating catalyst. The support can, for example, be an open-pored foam structure, for example a metal foam, a metal alloy foam, a silicon carbide foam, an Al₂O₃ foam, a mullite foam, an Al-titanium foam as well as a monolithic support structure, which for example has channels aligned parallel to each other which can be connected to each other by conduit or contain specific internal components for swirling gas.

Likewise preferred supports are for example formed from a sheet, any metal or a metal alloy, which have a metal foil or sintered metal foil or a metal fabric and are produced for example by extrusion, coiling or stacking. In the same way, supports made of ceramic material can be used. The ceramic material is frequently an inert material with a small surface area, such as cordierite, mullite, alpha-aluminium oxide, silicon carbide or aluminium titanate. However, the support used can also consist of a material with a large surface area, such as gamma-aluminium oxide or TiO₂.

According to an embodiment of the catalyst according to the invention, the zeolite material/binder weight ratio is 80/20 to 60/40, more preferably 75/25 to 65/35 and most preferably approximately 70/30. The BET surface area of the catalyst according to the invention is preferably in the range of from 10 to 600 m²/g, more preferably 50 to 500 m²/g, and most preferably 100 to 450 m²/g. The BET surface area is determined by adsorption of nitrogen according to DIN 66132.

A subject of the invention is furthermore a method of producing the catalyst according to the invention, comprising the following steps:
a) introducing a noble metal precursor compound into a microporous zeolite material;
b) calcining the zeolite material loaded with the noble metal precursor compound;
c) mixing the zeolite material loaded with the noble metal compound with a porous SiO₂-containing binder and a solvent;
d) drying and calcining the mixture comprising the zeolite material loaded with the noble metal compound and the binder.

The mixture obtained in step c) can be applied to a support before drying and calcining, wherein a coating catalyst is formed.

Depending on the intended use, i.e. the reaction to be catalyzed, the noble metal of the zeolite material is present either as noble metal in metallic form or as noble metal oxide.

If a metallic form of the noble metal is required, the metal of the noble metal compound with which the zeolite material is loaded is converted to its metallic form as a further method step. The noble metal compound is usually converted to the corresponding noble metal by thermal decomposition or by reduction by means of hydrogen, carbon monoxide or wet-chemical reducing agent. The reduction can also be carried out in situ at the start of a catalytic reaction in a reactor.

According to an embodiment of the method according to the invention, the noble metal compound is introduced by impregnating the zeolite material with a solution of a noble metal precursor compound, for example by spraying a solution onto the zeolite material. It is thereby guaranteed that the surface of the zeolite material will be largely evenly covered with the noble metal precursor compound. The essentially even covering of the zeolite material with the noble metal precursor compound forms the basis for the largely uniform loading of the zeolite material with the noble metal particles in the subsequent calcination step, which leads to the decomposition of the noble metal precursor compound, or in the conversion of the metal compound into the corresponding metal. The zeolite material is particularly preferably impregnated according to the incipient wetness method known to a person skilled in the art. For example, nitrates, acetates, oxalates, tartrates, formates, amines, sulphides, carbonates, halides or hydroxides of the corresponding noble metals can be used as noble metal precursor compound.

After the impregnation of the zeolite material with the noble metal precursor compound, a calcining is carried out, preferably at a temperature of from 200 to 800° C., more preferably 300 to 700° C., most preferably 500 to 600° C. The calcining is preferably carried out according to the invention under protective gas, for example nitrogen or argon, preferably argon.

In other respects, the same preferences apply for the method as for the above-named catalyst.

A subject of the invention is moreover the use of the catalyst according to the invention as oxidation catalyst, in particular as catalyst for the oxidation of organic pollutants and in particular of solvent-type organic pollutants.

The invention will now be described with reference to some embodiment examples which are not to be considered as limiting the scope of the invention. Reference is made in addition to the figures.

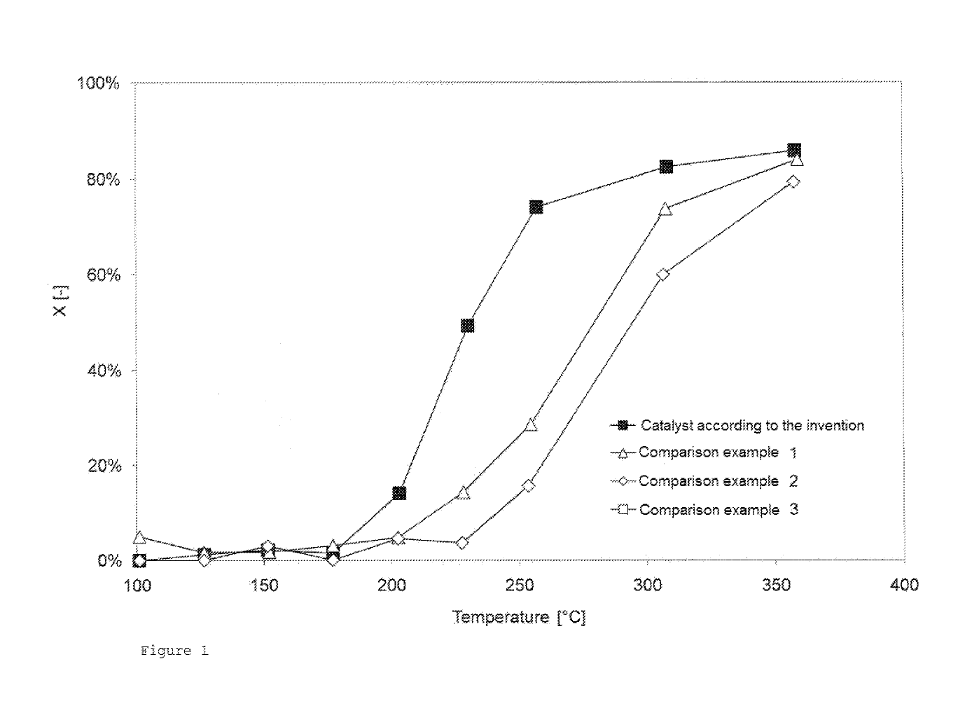

FIG. 1 shows the performance of the catalyst according to the invention in the oxidation of 180 ppmv ethyl acetate in air at a GHSV of 40000 h⁻¹ compared with conventional reference materials.

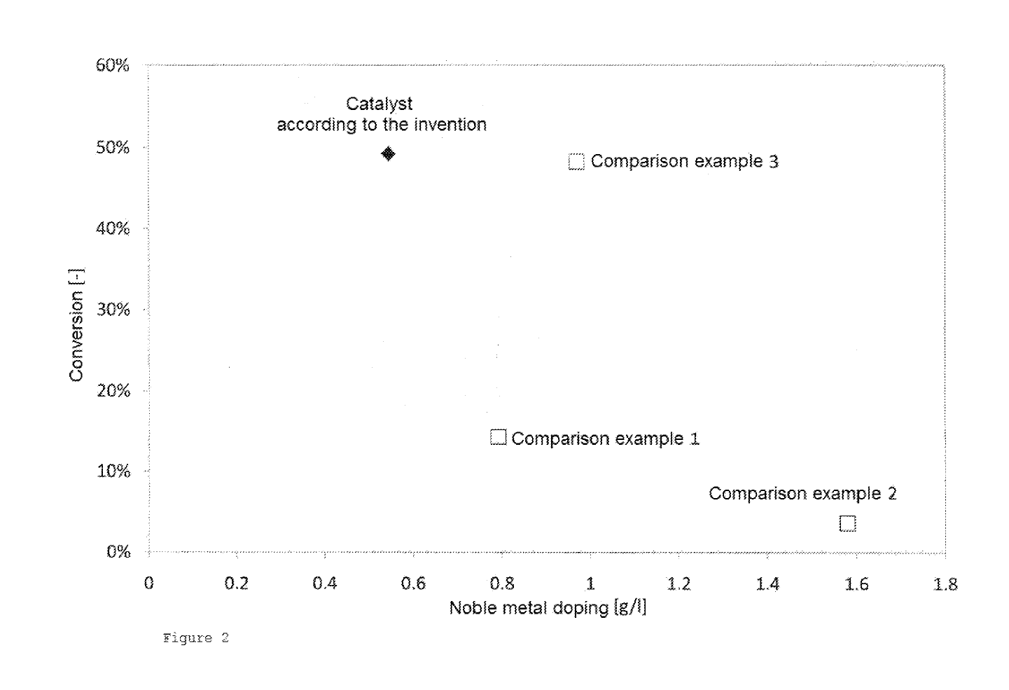

FIG. 2 shows a comparison of the conversion at a temperature of 225° C., plotted against the noble metal doping.

### EMBODIMENT EXAMPLE 1

A H-BEA-150 zeolite was dried overnight for approx. 16 h at 120° C. in order to obtain an informative result later during the water absorption. The water absorption of the zeolite was then determined by means of the “incipient wetness” method. For this, approx. 50 g of the zeolite to be impregnated was added to a bag, a container tared with water and water added and kneaded in until the zeolite was still just about absorbing the water (absorption: 38.68 g=77.36%).

An acid Pt—(NO₃)₂ solution was used for the Pt impregnation (15.14 wt.-%). As, in this case, the Pt loading is predetermined by the solids loading in the honeycomb, the reference loading must be back-calculated with the Pt quantity to be doped.

The target loading of the honeycomb is 30 g/l. At 3.375 l per honeycomb, this corresponds to a reference loading of 101.25 g washcoat with a noble metal loading of 0.5 g/l (m reference _{(at 3.375 l)}=1.68 g). The ratio of zeolite to Bindzil was 70/30. Solids content (Bindzil, wt.-% SiO₂=34%); m (reference loading without Bindzil)=90.92 g Pt-BEA-150.

At a Pt content of 1.68 g, a BEA-150 is thus to be impregnated with 1.85% Pt. For 1500 g Pt-BEA-150, this corresponds to a Pt loading of 27 g and thus a quantity of Pt—(NO₃)₂ solution (wt.-% Pt=15.14) of 183.88 g. At an absorption of 77.36%, the Pt—(NO₃)₂ solution must be diluted with 1008.65 g water once more.

The impregnation was carried out in a mixer from Netzsch with a butterfly agitator. For this, the quantity of zeolite was pre-weighed in a container (can) (1 can=102.77 g corresponding to 15 cans at 1500 g). The total quantity of the solution was extrapolated to the number of cans (at 102.77 g zeolite->79.50 g Pt—(NO₃)₂ solution which consists of 12.26 g Pt—(NO₃)₂ and 67.24 g demineralized water). The mixture was started at 250 rpm and the solution was added slowly. The rotational speed was increased during the addition. After the solution had been added, the rotational speed was increased to 500 rpm and stirring was carried out for approx. 0.5 min. The powder was then transferred into a ceramic bowl and dried at 120° C. for approx. 6 h. Then the Pt zeolite was calcined at 550° C./5 h (heating rate 60° C./h) under argon (throughflow 50 l/h). During this, the noble metal remains almost exclusively in the micropores of the catalyst, which results in a very high oxidative activity and stability at a high concentration of water vapour.

Ceramic Honeycomb Coating:

Washcoat type: Pt-BEA-150

Reference loading [g/l]: 30.00

Reference loading [g]: 101.25

Support material Ceramic substrate, 100 cpsi

Size

Length: [dm]: 1.500

Width: [dm]: 1.500

Height: [dm]: 1.500

Volume: [l]: 3.3750

Washcoat Production:

Amounts used:

Demineralized water 2052.0 g Conductivity: 1.0 μS

Pt-BEA-150 1359.30 g LOI [%] 1.50 1380.0 g

Bindzil 2034 DI 377.40 g FS [%] 34.00 691.90 g

Before preparation, the particle size distribution of the zeolite powder was measured in physical analysis.

Result: D10=3.977 μm; D50=10.401 μm; D90=24.449 μm

The test was carried out according to a standard method. The preparation container was a 5 l beaker. The zeolite powder was suspended in demineralized water and the pH was measured (pH: 2.62). The Bindzil was added to the suspension and the pH was measured (pH: 2.41). The suspension was then dispersed with an Ultra Turrax stirrer for approx. 10 min. A sample was taken from the suspension and the particle distribution was determined.

Results after Ultra Turrax: D10=2.669 μm; D50=6.971 μm; D90=18.575 μm

The washcoat was further stirred on a magnetic stirrer and used for coating.
Solids content [%] 40.10
pH: 2.41

Coating

The washcoat was diluted with 15% demineralized water. The solids content after dilution was 13.62%. For the coating, the washcoat was stirred until no more sediment remained and the washcoat was measured. For this, the support was completely immersed in the washcoat container and moved until no more bubbles formed (time: approx. 30 s) The support was then retrieved and blown with a compressed air nozzle from both sides evenly to approximately half of the reference loading. The support was dried at 150° C. overnight. A circulating air drying oven was used for drying. After drying, the support was cooled and weighed. If the reference loading was not achieved, the support was coated further until the reference value was achieved. The coated honeycombs were dried between the coatings. Calcining was then carried out under standard conditions in a circulating air oven.

| | | | | |
|---|---|---|---|---|
| Heating | Time [h] | 4 | Temperature [° C.] | from 40 to 550 |
| Holding | Time [h] | 3 | Temperature [° C.] | at 550 |
| Cooling | Time [h] | 4 | Temperature [° C.] | from 550 to 80 |

Washcoat type: Pt-BEA-150

TABLE 1
Coating results

| Support number | 1 | 2 | 3 | 4 | 5 | 6 |
|---|---|---|---|---|---|---|
| 1st coating empty weight [g] | 1806 | 1781 | 1811 | 1770 | 1802 | 1806 |
| 1st coating moist - reference [g] | 2549 | 2524 | 2554 | 2513 | 2545 | 2549 |
| 1st coating moist - actual [g] | 2120 | 2118 | 2123 | 2108 | 2133 | 2145 |
| 1st coating dry [g] | 1830 | 1812 | 1835 | 1802 | 1836 | 1840 |
| 1st coating loading [g] | 25 | 31 | 24 | 32 | 34 | 34 |
| 2nd coating empty weight [g] | 1830 | 1812 | 1835 | 1802 | 1836 | 1840 |
| 2nd coating moist - reference [g] | 0 | 2524 | 2554 | 2513 | 2545 | 2549 |
| 2nd coating moist - actual [g] | 2152 | 2159 | 2177 | 2160 | 2167 | 2194 |
| 2nd coating dry [g] | 1856 | 1845 | 1868 | 1841 | 1868 | 1881 |
| 2nd coating loading [g] | 26 | 33 | 33 | 39 | 32 | 41 |
| 3rd coating empty weight [g] | 1856 | 1845 | 1868 | 1841 | 1868 | 1881 |
| 3rd coating moist - reference [g] | 2599 | 2588 | 2611 | 2584 | 2611 | 2624 |
| 3rd coating moist - actual [g] | 2196 | 2206 | 2192 | 2185 | 2193 | 2224 |
| 3rd coating dry [g] | 1879 | 1882 | 1897 | 1878 | 1901 | 1916 |
| 3rd coating loading [g] | 23.00 | 37.00 | 29.00 | 37.00 | 33.00 | 35.00 |
| 4th coating empty weight [g] | 1879 | | 1897 | | | |
| 4th coating moist - reference [g] | 1885 | | 1903 | | | |
| 4th coating moist - actual [g] | 2189 | | 2225 | | | |
| 4th coating dry [g] | 1911 | | 1947 | | | |
| 4th coating loading [g] | 32.00 | 0.00 | 50.00 | 0.00 | 0.00 | 0.00 |
| Total loading [g] | 105.5 | 100.90 | 136.10 | 108.20 | 98.90 | 110.40 |
| Total loading [g/l] | 31.26 | 29.90 | 40.33 | 32.06 | 29.30 | 32.71 |
| Weight, calcined [g] | 1911.00 | 1881.00 | 1947.00 | 1880.00 | 1898.00 | 1915.00 |
| Total loading, calcined [g] | 105.50 | 99.90 | 136.10 | 110.20 | 95.90 | 109.40 |
| Total loading [g/l] | 31.26 | 29.60 | 40.33 | 32.65 | 28.41 | 32.41 |

The proportions of micro- and meso/macropores of the catalysts according to the invention were investigated by means of the t-plot method and the values evaluated in m²/g (see Table 2).

TABLE 2
Pore proportion

| | | | |
|---|---|---|---|
| Sio₂ binder [wt.-%] | 10% | 20% | 40% |
| Micropores [m²/g] | 461 | 415 | 358 |
| Meso/macropores [m²/g] | 121 | 125 | 134 |
| Total pores [m²/g] | 582 | 549 | 492 |

### COMPARISON EXAMPLE 1

A ceramic honeycomb was coated with 50 g/l of a washcoat consisting of wt.-% TiO₂ and 20 wt.-% Al₂O₃. For this, the aqueous TiO₂/Al₂O₃ suspension was first agitated intensively. The ceramic honeycomb was then immersed into the washcoat suspension. After immersion, non-adhering washcoat was removed by blowing the honeycomb channels. The honeycomb body was then dried at 120° C. and calcined at 550° C. for 3 h. The noble metal was applied by immersing the catalyst honeycomb coated with washcoat into a solution of Pt nitrate and Pd nitrate. After impregnation, the honeycomb was blown again, dried at 120° C. for 2 h and calcined at 550° C. for 3 h.

### COMPARISON EXAMPLE 2

A ceramic honeycomb was coated with 100 g/l of a washcoat consisting of Al₂O₃. For this, the aqueous Al₂O₃ suspension was first agitated intensively. The ceramic honeycomb was then immersed into the washcoat suspension. After immersion, non-adhering washcoat was removed by blowing the honeycomb channels. The honeycomb body was then dried at 120° C. and calcined at 550° C. for 3 h. The noble metal was applied by two impregnation steps with intermediate drying and calcining. In the first part-step, the honeycomb coated with washcoat was impregnated by immersion into a solution of Pt sulphite. After impregnation, the honeycomb was blown, dried at 120° C. for 2 h and calcined at 550° C. for 3 h. In a second part-step, the honeycomb was impregnated with a solution of tetraammine Pd nitrate by immersion. The honeycomb was then blown again, dried at 120° C. for 2 h and calcined at 550° C. for 3 h.

### COMPARISON EXAMPLE 3

A dried H-BEA-35 was loaded with an acid Pt—(NO₃)₂ solution by means of the “incipient wetness” method. For this, 48.5 g H-BEA-35 was impregnated with 47.1 g of a Pt—(NO₃)₂ solution containing 3.2 wt.-% Pt. After impregnation, the material was dried overnight at 120° C. and then calcined under argon. The calcining was carried out for 5 h at 550° C., the heating rate beforehand was 2 K/min. The finished Pt-BEA-35 powder contained 3 wt.-% Pt.

A catalyst honeycomb of cordierite was then coated with the pulverulent Pt-BEA material. For this, 33.3 g Pt-BEA material, 57 g H-BEA 35 and 29.4 g Bindzil (binder material, containing 34 wt.-% SiO₂) were dispersed in 300 g water and then ground to a washcoat in a planetary ball mill at 350 rpm in 5-minute intervals for 30 min. The suspension was then transferred into a plastic bottle in each case, in order to coat the cordierite honeycomb (200 cpsi) with it. The achieved coating quantity was 100 g/l w/c. After coating, the honeycomb was calcined for 5 h at 550° C.

The noble metal dopings of all of the catalyst honeycombs are summarized in Table 3 below.

TABLE 3
Noble metal contents

| | Washcoat | Noble metal content [g/L] |
|---|---|---|
| Catalyst according to | Pt-BEA 150 | Pt 0.54 |
| the invention | | |
| Comparison example 1 | TiO₂/Al₂O₃ | Pt 0.66 Pd 0.13 |
| Comparison example 2 | Al₂O₃ | Pt 1.32 Pd 0.26 |
| Comparison example 3 | Pt-BEA35 | Pt 0.97 |

Catalytic Tests

The performance of the catalyst according to the invention was determined in the oxidation of 180 ppmv ethyl acetate in air at a GHSV of 40000 h⁻¹ and compared with that of conventional reference materials. The results are contained in FIG. 1 (data in Tables 4 to 7). In comparison example 3, the performance data were scaled to a comparable active honeycomb surface area, wherein points >90% conversion were omitted. FIG. 2 (data in Table 8) shows a comparison of the conversion at a temperature of 225° C., plotted against the noble metal doping, with the result that the improvement in performance of the catalyst according to the invention is made clearer.

TABLE 4
BEA150/550° C.

Catalyst according to the invention

| Ethyl acetate | T ave. | |
|---|---|---|
| T cat in ° C. | [° C.] | X(EA) |
| 350 | 358 | 0.85829088 |
| 300 | 308 | 0.8241848 |
| 250 | 257 | 0.74022719 |
| 225 | 230 | 0.49238606 |
| 200 | 203 | 0.14086464 |
| 175 | 177 | 0.01479201 |
| 150 | 151.5 | 0.0213844 |
| 125 | 126.5 | 0.01206789 |
| 100 | 101 | 0 |

TABLE 5

Comparison example 1

| Ethyl acetate | T ave. | |
|---|---|---|
| T cat in ° C. | [° C.] | X(EA) |
| 350 | 359 | 0.83930539 |
| 300 | 307.5 | 0.73694979 |
| 250 | 254.5 | 0.28581921 |
| 225 | 228 | 0.143067 |
| 200 | 202.5 | 0.04795131 |
| 175 | 177 | 0.03100572 |
| 150 | 152 | 0.01731284 |
| 125 | 126.5 | 0.01647343 |
| 100 | 101 | 0.05004984 |

TABLE 6

Comparison example 2

| Ethyl acetate | T ave. | |
|---|---|---|
| T cat in ° C. | [° C.] | X(EA) |
| 350 | 357.5 | 0.79291201 |
| 300 | 306.5 | 0.59849077 |
| 250 | 253.5 | 0.15655572 |
| 225 | 227.5 | 0.03657189 |
| 200 | 202.5 | 0.04578898 |
| 175 | 177 | 0 |
| 150 | 151.5 | 0.03026546 |
| 125 | 126.5 | 0 |
| 100 | 101 | 0 |

TABLE 7

| Comparison example 3 | | | 80000 h⁻¹ |
|---|---|---|---|
| Ethyl acetate | T ave. | Pt-BEA35 | Scaled over active |
| T catalyst in ° C. | [° C.] | X(EA) | surface area to 100 cpsi |
| 350 | 360.5 | 0.97468104 | |
| 300 | 309.5 | 0.96286223 | |
| 250 | 259.5 | 0.89021857 | 0.6148467 |
| 225 | 232.5 | 0.69879339 | 0.48263519 |
| 200 | 205 | 0.3460093 | 0.23897802 |
| 175 | 178.5 | 0.17144694 | 0.11841315 |
| 150 | 152.5 | 0.09633073 | 0.06653268 |
| 125 | 127 | 0.0270003 | 0.01864828 |
| 100 | 102 | 0 | 0 |

TABLE 8

| | Cell | | WC loading | Pt | Pd | | X(EA) |
|---|---|---|---|---|---|---|---|
| | density | WC | g/l | g/l | g/l | Total NM | 225° C. |
| Catalyst according | 100 | Pt- | 30 | 0.54 | | 0.54 | 0.492 |
| to the invention | | BEA150 | | | | | |
| Comparison example 1 | 100 | D530 | 50 | 0.66 | 0.13 | 0.79 | 0.143 |
| Comparison example 2 | 100 | SCFa 140 | 100 | 1.32 | 0.26 | 1.58 | 0.037 |
| | | (PT1358) | | | | | |
| Comparison example 3 | 200 | Pt-BEA35 | 97.10 | 0.97 | | 0.97 | 0.482 |

1-12. (canceled)

13. A method of purifying exhaust, the method comprising:
providing an exhaust gas containing an organic pollutant;
oxidizing the exhaust gas with a catalyst under conditions sufficient to oxidize the organic pollutant, the catalyst comprising
a microporous noble metal-containing zeolite material, the zeolite material having less than 2 mol. % aluminium, the zeolite material being selected from zeolites of the types AFI, AEL, BEA, CHA, EUO, FAU, FER, KFI, LTL, MAZ, MOR, MEL, MTW, OFF, TON and MFI, the noble metal being selected from the group consisting of rhodium, iridium, palladium, platinum, ruthenium, osmium, gold and silver and combinations thereof; and
a porous SiO₂-containing binder having less than 0.04 wt % aluminium,
wherein the catalyst has a proportion of micropores having a diameter of less than 1 nm of more than 70% relative to the total pore volume of the catalyst.

14. The method according to claim 13, wherein the exhaust gas is an exhaust gas from a combustion process.

15. The method according to claim 13, wherein the exhaust gas is an exhaust gas from a power plant.

16. The method according to claim 13, wherein the exhaust gas is an exhaust gas from an industrial process.

17. The method according to claim 13, wherein the oxidation is performed at a temperature below 300° C.

18. The method according to claim 13, wherein the organic pollutant is a solvent-type organic pollutant.

19. The method according to claim 13, wherein the organic pollutant is a paraffin, an olefin, an aldehyde or an aromatic.

20. The method according to claim 13, wherein the catalyst is provided as a coating on a support.

21. The method according to claim 20, wherein the support is a metal foam.

22. The method according to claim 20, wherein the support is a honeycomb-shaped monolith.

23. The method according to claim 13, wherein the zeolite material of the catalyst contains 0.5-3.0 wt % noble metal relative to the amount of zeolite material.

24. The method according to claim 13, wherein the catalyst has a zeolite material/binder weight ratio in the range of 80:20 to 60:40.

25. The method according to claim 13, wherein the catalyst has an integral pore volume greater than 180 mm³/g.

26. The method according to claim 13, wherein the noble metal is selected from the group consisting of palladium, platinum, and combinations thereof.

27. The method according to claim 13, wherein the catalyst has a proportion of mesopores having a diameter of 1-50 nanometers and macropores having a diameter in excess of 50 nanometers in the range of 20-30% as compared to the total pore volume of the catalyst.

28. The method according to claim 13, wherein the calcining provides a catalyst having a proportion of micropores having a diameter less than 1 nm of greater than 72% as compared to the total pore volume of the catalyst.

29. The method according to claim 13, wherein the microporous zeolite material has less than 1 mol % aluminium.

30. The method according to claim 13, wherein the binder has less than 0.02 wt % aluminium.

31. The method according to claim 13, wherein
the zeolite material of the catalyst contains 0.5-6.0 wt % noble metal relative to the amount of zeolite material, the noble metal being selected from the group consisting of rhodium, iridium, palladium, platinum, ruthenium, osmium, gold and silver and combinations thereof;
the zeolite material has less than 1 mol % aluminium;
the catalyst has an integral pore volume greater than 100 mm³/g; and
the catalyst has a proportion of mesopores having a diameter of 1-50 nanometers and macropores having a diameter in excess of 50 nanometers in the range of 20-30% as compared to the total pore volume of the catalyst.

32. The method according to claim 13, wherein
the zeolite material of the catalyst contains 0.5-3.0 wt % noble metal relative to the amount of zeolite material, the noble metal being selected from the group consisting of palladium, platinum, and combinations thereof;
the microporous zeolite material has less than 1 mol % aluminium;
the binder has less than 0.02 wt % aluminium;
the catalyst has an integral pore volume greater than 180 mm³/g; and
the catalyst has a proportion of micropores having a diameter less than 1 nm of greater than 72% as compared to the total pore volume of the catalyst
